(19) United States
(12) Patent Application Publication
(10) Pub. No.: US 2003/0160743 A1
(43) Pub. Date: Aug. 28, 2003

(54) Color organic EL display device

(76) Inventor: Hitoshi Yasuda, Motosu-gun (JP)

Correspondence Address: Barry E. Bretschneider, Morrison & Foerster LLP, Suite 300, 1650 Tysons Boulevard, McLean, VA, 22102, US

(21) Appl. No.: 10/374,057

(22) Filed: Feb. 27, 2003

(30) Foreign Application Priority Data
Feb. 27, 2002 (JP) 2002-052143

(51) Int. Cl. G09G 3/30

(52) U.S. Cl. 345/76

(57) ABSTRACT

The invention provides an active color electroluminescent display device that includes an electroluminescent element having a red light emitting layer, a green light emitting layer and a blue light emitting layer. The red, green and blue light emitting layers are disposed between a cathode and corresponding anodes. The device also includes a red gamma correction DAC, a green gamma correction DAC and a blue gamma correction DAC that are electrically connected to the anodes of the corresponding light emitting layers. The reference voltages of the DAC's are adjusted according to the electroluminescent properties of the RGB light emitting layers.

### BACKGROUND OF THE INVENTION

1 Field of the Invention

This invention relates to an active type color organic electroluminescent (EL) display device, which includes thin film transistors (TFT) to drive EL elements.

2. Description of the Prior Art

Organic EL elements emit light on their own and thus do not require a back light, which is required in a liquid crystal display device, and are thus optimal for realizing a slim device design. These elements also do not have restrictions in terms of view angle and are thus expected to become next-generation display devices.

With a display device using such an organic EL element, it is most efficient to employ a method in which different light emitting materials are used in light emitting layers according to the three primary colors of RGB and pixels that directly emit R, G, and B light, respectively, are formed to directly emit the corresponding light independent of each other.

There are two types of methods for driving an organic EL display device, i.e., a passive type, in which a simple matrix is used, and an active type, in which TFT's are used. With the active type, the circuit arrangement shown in FIG. 7 is generally used.

FIG. 7 shows a circuit arrangement for a single pixel, which includes an organic EL element 20, a first TFT 21 for switching, which receives a display signal “Data” at a drain and turns on and off in accordance with a selection signal “Scan” applied to a gate, a capacitor 22, which is charged by the display signal when TFT 21 is on and holds a charge voltage Vh when TFT 21 is off, and a second TFT 23, which drives the organic EL element 20. The drain of the second TFT 23 is connected to a drive power supply voltage COM, and its source is connected to an anode of the organic EL element 20. A hold voltage Vh from capacitor 22 is supplied to the gate of the second TFT 23.

The selection signal is at a H (high) level during a single, selected horizontal scan period (1H), and when TFT 21 is thereby turned on, the display signal is supplied to one end of capacitor 22 and the capacitor 22 is charged by the voltage Vh, corresponding to the display signal. Even when the selection signal becomes a L (low) level and TFT 21 is turned off, the voltage Vh continues to be held by capacitor 22 for a single vertical scan period (IV). Since this voltage Vh is supplied to the gate of TFT 23, the EL element emits electroluminescent light that corresponds to voltage Vh.

A conventional arrangement of such an active type EL display device, in which light emitting materials of the three different primary colors, RGB, are used, will be described first.

FIG. 8 is a plan view of an electroluminescent element of a conventional device with RGB pixel arrangement, and FIG. 9 is a sectional view of the device along line C-C in FIG. 8.

A drain line 50 supplies the display signal. A power supply line 51 supplies a power supply voltage COM. A gate line 52 supplies the selection signal. The first TFT 21 of FIG. 7 is indicated by reference numeral 53, the capacitor 22 of FIG. 7 is indicated by reference numeral 54, and the second TFT 23 of FIG. 7 is indicated by reference numeral 55. An anode 56 of EL element 20 is a pixel electrode. An anode 56 is formed on a planarizing insulation film 60 for each of the pixels. An EL element is formed by successively laminating a hole transport layer 61, a light emitting layer 62, an electron transport layer 63, and a cathode 64 above the anode. By recombination of holes injected from anode 56 with electrons injected from cathode 64 inside light emitting layer 62, light is emitted. This light is radiated from the transparent anode side to the exterior as indicated by the arrow in FIG. 9. Hole transport layer 61, light emitting layer 62, and electron transport layer 63 are formed to have substantially the same shape as anode 56 for each of the pixels. By use of different light emitting materials that corresponds to RGB light emission, the light of RGB are emitted respectively from the respective EL elements. The cathode 64 extends across the respective pixels since it applies a common voltage to each pixel. Light emitting layers 62 are partitioned from each other by a barrier 68. The device also includes a transparent glass substrate 65, a gate insulation film 66, and an interlayer insulation film 67. In the configuration of FIG. 8, each pixel is a red right emitting pixel, a green light emitting pixel or a blue light emitting pixel, and an electroluminescent element of an EL device includes one R pixel, one G pixel and one B pixel.

With the above-described organic EL display device, RGB video signals are corrected by a common gamma correction circuit 10 and supplied to an organic EL panel 20 for displaying an image. Gamma correction refers to converting the relationship in which the output luminance level is proportional to the gamma power of the input signal into the relationship in which the output luminance is proportional to the input signal.

However, with organic EL materials, since the materials for RGB differ in luminance characteristics, the resulting variations in luminance cause deviation of the color balance, and colors therefore can not be reproduced accurately for the RGB video signals.

Also, organic EL materials degrade and change in luminance characteristics as currents pass through and even if the color balance is adjusted in the initial state, the color balance deviates with elapse of time.

### SUMMARY OF THE INVENTION

The invention provides an active color electroluminescent display device that includes a plurality of electroluminescent elements each driving the having a red light emitting layer, a green light emitting layer and a blue light emitting layer. Each of the red, green and blue light emitting layers are disposed between a corresponding first electrode and a corresponding a second electrode. The device also includes a red gamma correction circuit, a green gamma correction circuit and a blue gamma correction circuit that are electrically connected to the corresponding first electrodes of the corresponding light emitting layers. The device further includes thin film transistors for electroluminescent elements.

The invention further provides an active color electroluminescent display device that includes an electroluminescent element having a red light emitting layer, a green light emitting layer and a blue light emitting layer. The red, green and blue light emitting layers are disposed between a corresponding first electrode and a corresponding second electrode. The device also includes a red gamma correction circuit, a green gamma correction circuit and a blue gamma correction circuit that are electrically connected to the corresponding first electrodes of the corresponding light emitting layers. The device also includes a memory storing output correction data for adjusting the red, green and blue gamma correction circuits. The device further includes thin film transistors for electroluminescent elements. The red, green and blue gamma correction circuits are adjusted based on the output correction data after a lapse of a predetermined accumulated display use time to provide a proper color balance.

### BRIEF DESCRIPTION OF THE DRAWINGS

FIG. 1 is a block diagram of a color organic EL display device of a first embodiment of this invention.

FIG. 2 is a circuit diagram of a digital-analog converter of the display device of the first embodiment.

FIG. 3 shows the luminescent intensity of the display device of the first embodiment as a function of the applied voltage as well as the input video signal.

FIG. 4 is a block diagram of a color organic EL display device of a second embodiment of this invention.

FIG. 5 is a circuit diagram of two digital-analog converters of the display device of the second embodiment.

FIG. 6 shows the luminescent intensity of the display device of the second embodiment after a lapse of display use time as a function of the applied voltage as well as the input video signal.

FIG. 7 is a circuit diagram of a conventional EL display device.

FIG. 8 is a plan view of the conventional organic EL display device of FIG. 7.

FIG. 9 is a sectional view of the device of FIG. 8 cut along line C-C of FIG. 8.

FIG. 10 is a block diagram of the conventional EL display device of FIG. 7.

### DETAILED DESCRIPTION OF THE INVENTION

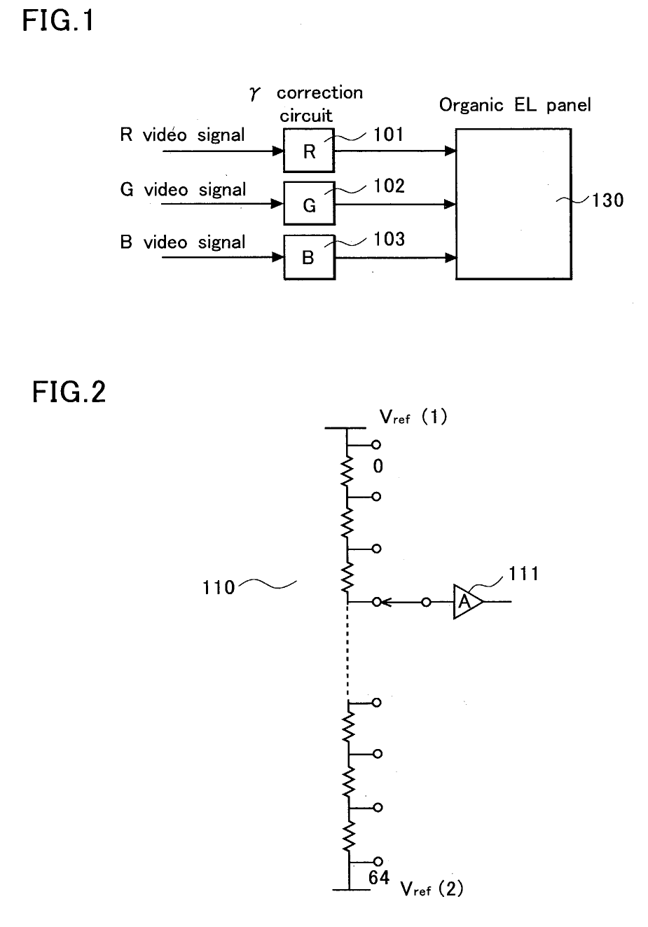

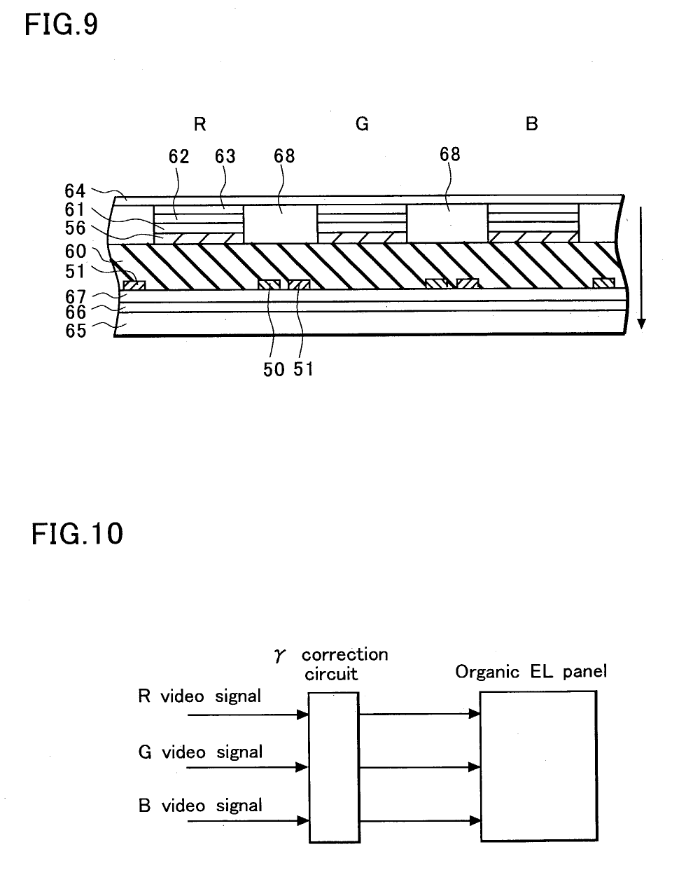

FIG. 1 is a block diagram for explaining a color organic EL display device of a first embodiment of this invention. Since the organic EL panel structure of this embodiment is the same as that described with reference to FIGS. 8 and 9, redundant descriptions will be omitted.

As shown in FIG. 1, this embodiment has the feature that the video signals of RGB are corrected by individual gamma correction circuits 101, 102, 103, and supplied to an organic EL panel 130 for displaying an image.

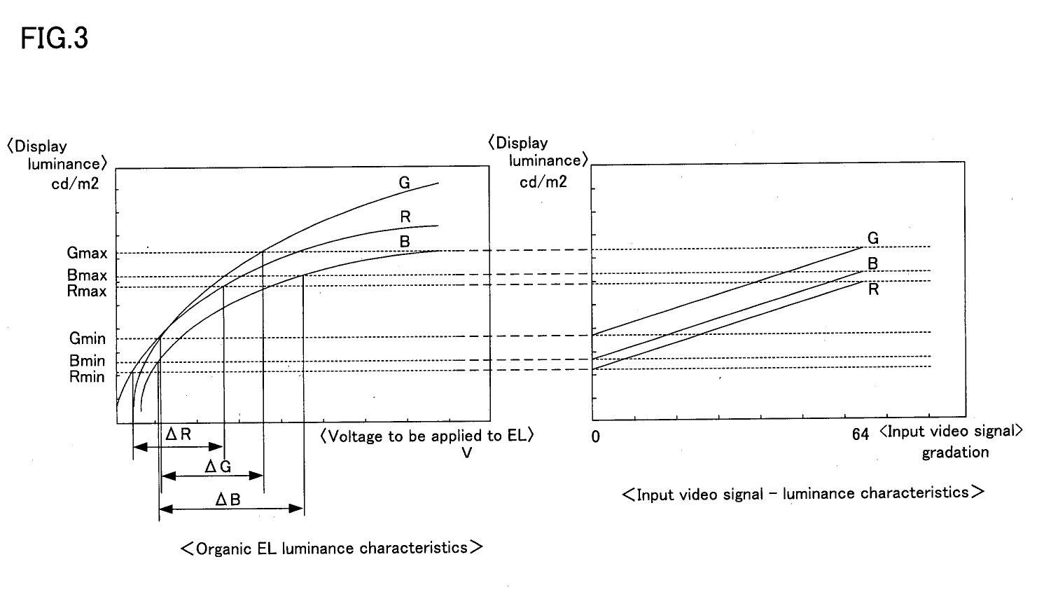

In FIG. 3, the initial-state luminance characteristics of the respective light emitting layers for RGB are shown at the left side, and the input gradation signal (input video signal)-luminance characteristics resulting from correction by the gamma correction circuits 101, 102, 103 are shown at the right side. That is, in order to maintain white balance, the luminance ratios of RGB are determined in the order of G, B, and R, and the gamma corrections are performed by the corresponding gamma correction circuits 101, 102, 103 so that the RGB luminance values vary proportionately to enable display of 64 gradations.

It is thus clear from the right side of FIG. 3 that for R, in order to drive the device in a range in which the luminance varies between Rmin and Rmax, voltages are adjusted within the range ΔR to provide 64 gradations. Such voltages are applied to the R light emitting layer. Also for G, in order to drive the device in a range in which the luminance varies between Gmin and Gmax, voltages are adjusted within the range ΔG and applied to the G light emitting layer to provide 64 gradations. Also for B, in order to drive the device in a range in which the luminance varies between Bmin and Bmax, voltages are adjusted within the range ΔB and applied to the B light emitting layer to provide 64 gradations.

Since the above ranges of ΔR, ΔG, and ΔB of the luminance characteristics vary widely depending on RGB, optimal gamma correction for each is carried out independently by each of gamma correction circuits 101, 102, 103 for RGB, respectively, as shown in FIG. 1.

A specific gamma correction circuit will now be described with reference to FIG. 2. A gamma correction circuit establishes the proportional relationship between luminance values and 64 gradation signals within each of the ranges of ΔR, ΔG, and ΔB as shown at the right side of FIG. 3.

A DAC (digital-analog converter) 110 is used to achieve this. Though only one DAC 110 is illustrated, this is obviously provided in each of the gamma correction circuits 101, 102, 103 for RGB, respectively. With DAC 110, 64 resistors are connected in series between one reference voltage Vref(1) and another reference voltage Vref(2), and by means of the connection points of the respective resistors and the reference voltages at both ends, the voltages for performing display in 64 gradations are switched by a switch to provide an input video signal to be input via an amplifier 111 into organic EL panel 130 to thereby obtain a predetermined luminance. These resistance values are adjusted according to RGB to enable display in 64 gradations.

For example, for an R video signal, the reference voltage Vref(1) is set to a voltage corresponding to the luminance Rmin, the other reference voltage Vref(2) is set to a voltage corresponding to the luminance Rmax, the difference between the reference voltages Vref(2) and Vref(1) is set to ΔR, and the respective resistance values of the 64 resistors are set within this range so that luminance values corresponding to 64 gradations can be obtained. Likewise, for a G video signal, the reference voltage Vref(1) is set to a voltage corresponding to the luminance Gmin, the other reference voltage Vref(2) is set to a voltage corresponding to the luminance Gmax, the difference between the reference voltages Vref(2) and Vref(1) is set to ΔG, and the respective resistance values of the 64 resistors are set within this range so that luminance values corresponding to 64 gradations can be obtained. Furthermore, for a B video signal, the reference voltage Vref(1) is set to a voltage corresponding to the luminance Bmin, the other reference voltage Vref(2) is set to a voltage corresponding to the luminance Bmax, the difference between the reference voltages Vref(2) and Vref(1) is set to ΔB, and the respective resistance values of the 64 resistors are set within this range so that luminance values corresponding to 64 gradations can be obtained.

As a result, even if the light emitting layers for RGB of the organic EL panel have different emission luminance characteristics as shown in FIG. 3, luminance display of 64 gradations is enabled for RGB, respectively, by the individual gamma correction circuits 101, 102, 103. Accordingly, this color organic EL display device achieves a good color balance. Though the number of gradations is 64 in this embodiment, the number of gradations may be 256 or other proper numbers.

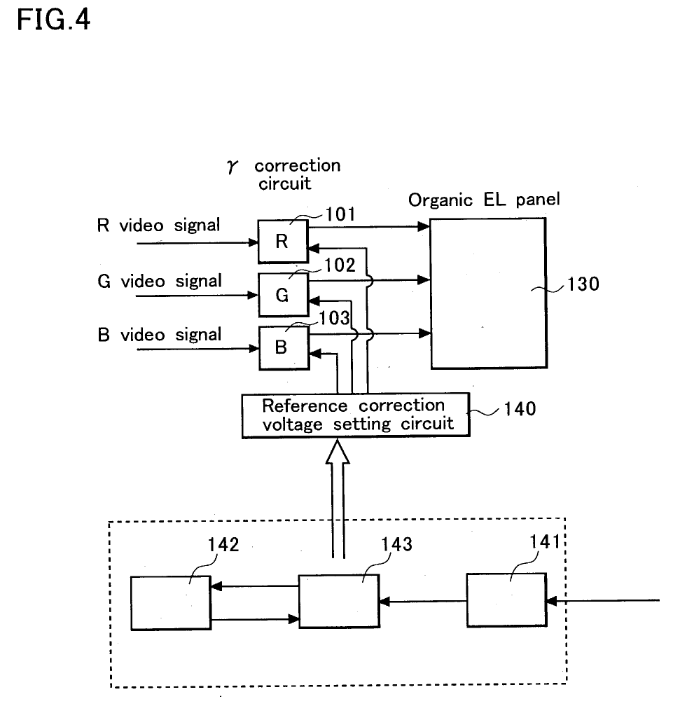

A second embodiment of this invention will now be described with reference to FIGS. 4 through 6. In this embodiment, the video signals for RGB are corrected by individual gamma correction circuits 101, 102, 103 and supplied to organic EL panel 130 as shown in FIG. 1 to display an image. Furthermore, the device of this embodiment, which is shown in FIG. 4, can accommodate time-dependent changes to the luminescent characteristics of the light emitting layers during use.

In FIG. 4, a reference correction voltage setting circuit 140 is provided respectively for the gamma correction circuits 101, 102, 103 for RGB, respectively. A time counter 141, a memory 142, which stores output correction data that are in accordance with display use time, and a CPU 143 are provided for the device. Time counter 141, for example, divides and accumulates a frame pulse (1/60) of the organic EL panel as a display use time accumulation signal that indicates the period for which the organic EL has been used. This accumulated time is inputted into CPU 143, the output correction data that are in accordance with the accumulated use time is read out from memory 142, and the reference voltage correction values are transmitted from CPU 143 to the reference correction voltage setting circuit 140.

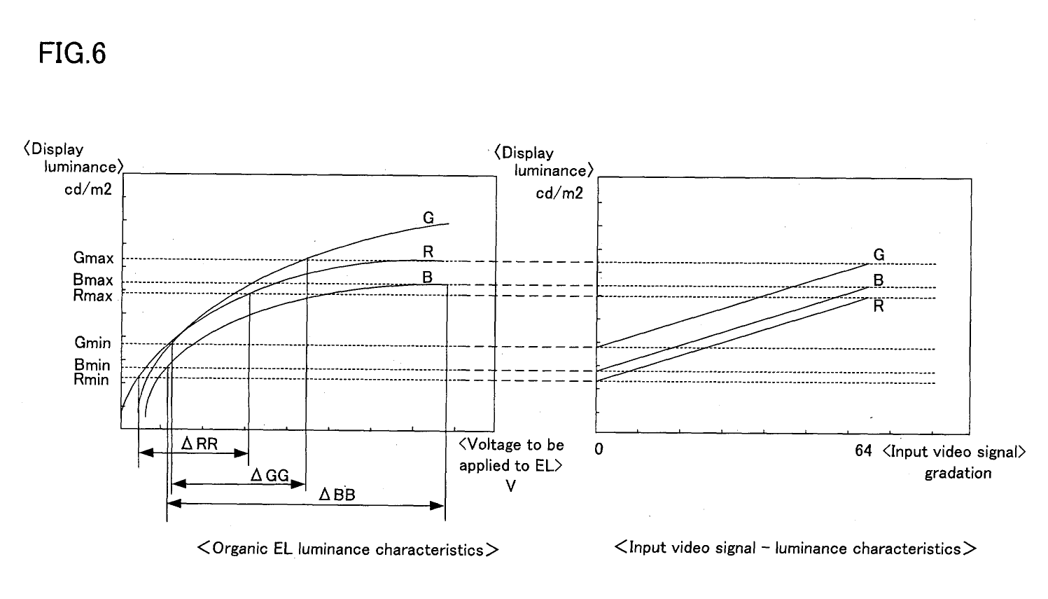

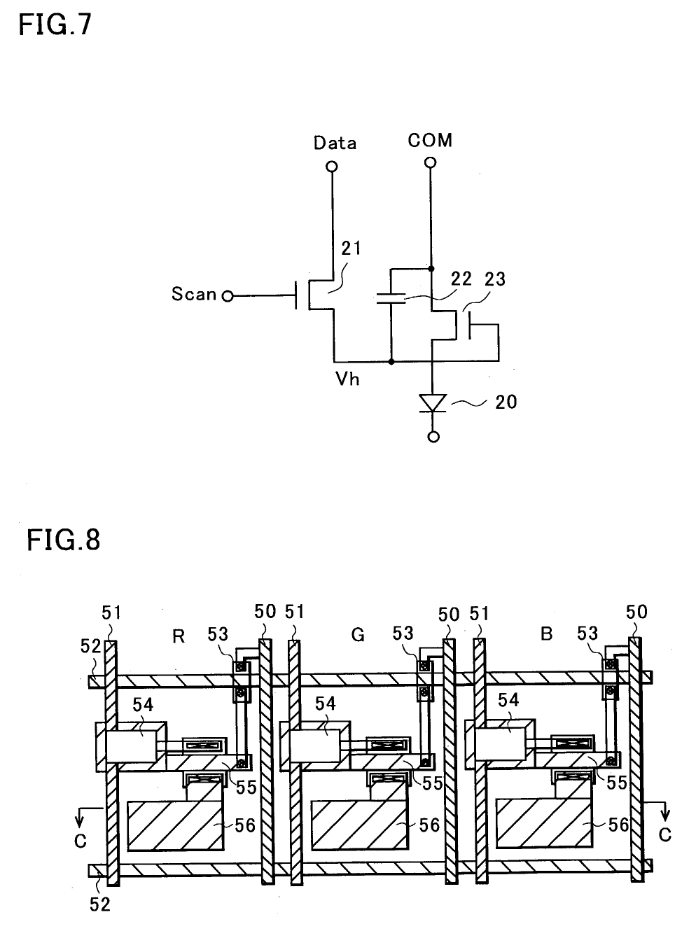

Degraded luminance characteristics for RGB after currents have passed through the device for some period of time are shown at the left side of FIG. 6. In the right side are shown the gamma-corrected input video signal—luminance characteristics for display in 64 gradations. The input video signal—luminance characteristics in FIG. 6 are the same as those of FIG. 4. A comparison with the left side of FIG. 4 shows that the characteristics for RGB at the high voltage side are lowered in luminance intensities.

Thus from the right side of FIG. 6, it is clear that for R, in order to drive the device in a range in which the luminance varies between Rmin and Rmax, voltages should be adjusted within the range ΔRR and applied to the R light emitting layer to provide 64 gradations. Also for G, in order to drive the device in a range in which the luminance varies between Gmin and Gmax, voltages should be adjusted within the range ΔGG and applied to the G light emitting layer to provide 64 gradations. Also for B, in order to drive the device in a range in which the luminance varies between Bmin and Bmax, voltages should be adjusted within the range ΔBB and applied to the B light emitting layer to provide 64 gradations. Thus in comparison to the initial state, the ranges ΔRR, ΔGG, and ΔBB are widened greatly towards the high application voltage side.

In this embodiment, the memory 142 stores the output correction data regarding the display use time and the time-dependent changes, i.e., ΔRR-ΔR, ΔGG-ΔG, and ΔBB-ΔB.

Specifically, when the display use time exceeds a predefined time at which the degradation of luminance occurs, this is detected by CPU 143, and the output correction data for RGB that is stored in memory 142 is read out and transmitted to reference correction voltage setting circuit 140. Based on the output correction data, the reference voltages Vref(2) are switched respectively at the gamma correction circuits 101, 102, 103 so that for R, the difference between reference voltage Vref(2) and Vref(1) is changed from ΔR to ΔRR, for G, the difference between reference voltage Vref(2) and Vref(1) is changed from ΔG to ΔGG, and for B, the difference between reference voltage Vref(2) and Vref(1) is changed from ΔB to ΔBB.

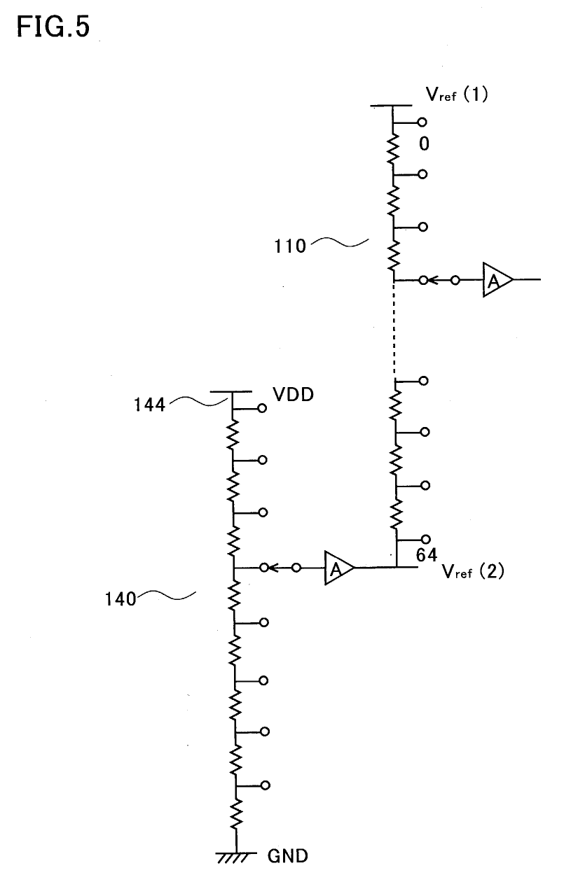

The reference correction voltage setting circuit 140 will now be described with reference to FIG. 5.

First, as is the case with the first embodiment, a DAC 110 is used as each of gamma correction circuits 101, 102, 103. This DAC 110 has 64 resistors connected in series between one reference voltage Vref(1) and another reference voltage Vref(2). By means of the connection points of the respective resistors and the reference voltages at both ends, the voltages for performing display in 64 gradations are switched by a switch to provide an input video signal to be input via an amplifier 111 into organic EL panel 130 to thereby obtain a predetermined luminance.

Each reference correction voltage setting circuit 140 is a DAC 144 that is connected to the reference voltage Vref(2) side, and takes out a voltage corresponding to the output correction data from resistors connected in series between Vdd and ground. Accordingly, the reference voltage Vref(2) is changed to a higher voltage. Reference voltages Vref(1) are for the low luminance side and do not have to be changed as degradation is small at this side.

For example, for an R video signal, since the one reference voltage Vref(1) is set to a voltage corresponding to the luminance Rmin and the other reference voltage Vref(2) is set to a voltage corresponding to the luminance Rmax, the difference between the reference voltages Vref(2) and Vref(1) is changed from ΔR to ΔRR. That is, the other reference voltage Vref(2) is shifted by the DAC 144 to a reference voltage that is higher by an amount corresponding to the output correction data for the difference (ΔRR−ΔR). This difference (ΔRR−ΔR) based on the output correction data is taken out from the DAC by the switching of the switch and is applied via an amplifier to the terminal of the other reference voltage Vref(2). Since the difference between reference voltage Vref(2) and Vref(1) of the gamma correction circuit 101 for R is thus changed from ΔR to ΔRR, display in 64 gradations in the same range of luminance as that of the initial state is enabled.

Also, for a G video signal, since the reference voltage Vref(1) is set to a voltage corresponding to the luminance Gmin and the other reference voltage Vref(2) is set to a voltage corresponding to the luminance Gmax, the difference between the reference voltages Vref(2) and Vref(1) is changed from ΔG to ΔGG. That is, the other reference voltage Vref(2) is shifted by a DAC 144 to a reference voltage that is higher by just an amount corresponding to the output correction data for the difference (ΔGG−ΔG). This difference (ΔGG−ΔG) based on the output correction data is taken out from the DAC by the switching of the switch and is applied via an amplifier to a terminal of the other reference voltage Vref(2). Since the difference between reference voltage Vref(2) and Vref(1) of the gamma correction circuit 101 for G is thus changed from ΔG to ΔGG, display in 64 gradations in the same range of luminance as that of the initial state is likewise enabled.

Furthermore, for a B video signal, since the reference voltage Vref(1) is set to a voltage corresponding to the luminance Bmin and the other reference voltage Vref(2) is set to a voltage corresponding to the luminance Bmax, the difference between the reference voltages Vref(2) and Vref(1) is changed from ΔB to ΔBB. That is, the other reference voltage Vref(2) is shifted by a DAC 144 to a reference voltage that is higher by just an amount corresponding to the output correction data for the difference (ΔBB−ΔB). This difference (ΔBB−ΔB) based on the output correction data is taken out from the DAC by the switching of the switch and is applied via an amplifier to a terminal of the other reference voltage Vref(2). Since the difference between reference voltage Vref(2) and Vref(1) of the gamma correction circuit 103 for B is thus changed from ΔB to ΔBB, display in 64 gradations in the same range of luminance as that of the initial state is likewise enabled. Since the degradation of luminance characteristics with current passage time is greatest for the B light emitting layer, the output correction for this layer will also be large.

Accordingly, this color organic EL display device achieves a good color balance and maintains the same luminance ranges as those of the initial device before use even after the device is in use for some time and the electroluminescent characteristics of the light emitting layers have been altered.

What is claimed is:

1. An active color electroluminescent display device comprising:
a plurality of electroluminescent elements each comprising a red light emitting layer, a green light emitting layer and a blue light emitting layer, each of the red, green and blue light emitting layers being disposed between a corresponding first electrode and a corresponding second electrode;
cathode and corresponding anodes;
a red gamma correction circuit electrically connected to the corresponding first electrode of the red light emitting layer;
a green gamma correction circuit electrically connected to the corresponding first electrode of the green light emitting layer;
a blue gamma correction circuit electrically connected to the corresponding first electrode of the blue light emitting layer; and
a plurality of thin-film transistor driving the corresponding electroluminescent elements.

2. The active color electroluminescent display device of claim 1, wherein the red, green and blue gamma correction circuits are configured to provide a proper color balance.

3. The active color electroluminescent display device of claim 1, wherein each of the red, green and blue gamma correction circuits comprises a digital-analog converter.

4. The active color electroluminescent display device of claim 3, wherein the reference voltages of the digital-analog converters are adjusted based on light emitting characteristics of the corresponding light emitting layers.

5. An active color electroluminescent display device comprising:
an electroluminescent element comprising a red light emitting layer, a green light emitting layer and a blue light emitting layer, each of the red, green and blue light emitting layers being disposed between a corresponding first electrode and a corresponding second electrode;
a red gamma correction circuit electrically connected to the corresponding first electrode of the red light emitting layer;
a green gamma correction circuit electrically connected to the corresponding first electrode of the green light emitting layer;
a blue gamma correction circuit electrically connected to the corresponding first electrode of the blue light emitting layer;
a memory storing output correction data for adjusting the red, green and blue gamma correction circuits; and
a thin-film transistor driving the electroluminescent element,
wherein the red, green and blue gamma correction circuits are adjusted based on the output correction data after a lapse of a predetermined accumulated display use time to provide a proper color balance.

6. The active color electroluminescent display device of claim 5, wherein each of the red, green and blue gamma correction circuits comprises a digital-analog converter.

7. The active color electroluminescent display device of claim 6, wherein the reference voltages of the digital-analog converters are adjusted based on the output correction data.

8. An active color electroluminescent display device comprising:
an electroluminescent element comprising a red light emitting layer, a green light emitting layer and a blue light emitting layer, the red, green and blue light emitting layers being disposed between a cathode and corresponding anodes;
a red gamma correction circuit electrically connected to the anode of the red light emitting layer;
a green gamma correction circuit electrically connected to the anode of the green light emitting layer; and
a blue gamma correction circuit electrically connected to the anode of the blue light emitting layer.
